(19) United States
(12) Patent Application Publication
(10) Pub. No.: US 2019/0172170 A1
(43) Pub. Date: Jun. 6, 2019

(54) SEATING RECOMMENDATION SYSTEMS AND METHODS FOR SHARED VEHICLES

(71) Applicant: GM Global Technology Operations LLC, Detroit, MI (US)

(72) Inventors: Joseph Jabour, Northville, MI (US); Michael Ames, Lake Orion, MI (US)

(73) Assignee: GM Global Technology Operations LLC, Detroit, MI (US)

(21) Appl. No.: 15/831,449

(22) Filed: Dec. 5, 2017

(51) Int. Cl. G06Q 50/30; G06Q 30/06; G06Q 10/02; G06K 9/00; G06F 17/30

(52) U.S. Cl. CPC G06Q 50/30; G06Q 30/0643; G06F 17/30241; G06Q 10/02; G06K 9/00838; G06Q 30/0645

(57) ABSTRACT

A communication module is configured to: obtain a ride request including: pickup and drop-off locations; and a first number of passengers to transport; and obtain, from each vehicle of a fleet of vehicles: a location of the vehicle; and a seat occupancy of the vehicle including, for each seat, an indicator of whether the seat is presently occupied by a passenger or not. A vehicle selection module is configured to select one of the vehicles when the one of the vehicles has a second number of unoccupied seats that is greater than or equal to the first number of passengers. A seat module is configured to selectively determine recommended ones of the unoccupied seats, and the communications module is further configured to transmit, to the computing device for display by the computing device, indicators of the occupied seats and the recommended ones of the unoccupied seats.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for managing shared vehicles and more particularly to systems and methods for notifying passengers of seating recommendations.

Rideshare systems allow users to request transportation from a pick-up location to a drop-off location. Rideshare systems may include a fleet of human-operated vehicles (e.g., cars, vans, buses, bicycles, motorcycles, etc.) that are utilized to transport the users from requested pickup locations to requested drop-off locations.

A rideshare system may determine which vehicle to assign to satisfy a particular request based on at least one of: (i) proximity between a requested pickup location and locations of the vehicles; and (ii) estimated period for the vehicles to reach the requested pickup location. For example, a rideshare system may select the vehicle that at least one of: is closest to the requested pickup location; and has a smallest estimated period to arrival at the requested pickup location.

### SUMMARY

In a feature, a rideshare system includes a communication module configured to: obtain, from a computing device, a ride request including: a pickup location; a drop-off location; and a first number of passengers to transport; and obtain, from each vehicle of a fleet of vehicles: a unique identifier of the vehicle; a location of the vehicle; and a seat occupancy of the vehicle including, for each seat of the vehicle, an indicator of whether the seat is presently: occupied by a passenger; or not occupied by a passenger. A vehicle selection module is configured to select, for the ride request, one of the vehicles of the fleet of vehicles in response to a determination that: the seat occupancy of the one of the vehicles indicates that the one of the vehicles has a second number of unoccupied seats; and the second number of unoccupied seats is greater than or equal to the first number of passengers to transport. A seat module is configured to selectively determine recommended ones of the unoccupied seats of the one of the vehicles for the first number of passengers to occupy during transport, and the communications module is further configured to transmit, to the computing device for display by the computing device, indicators of the occupied seats of the one of the vehicles and one or more indicators of the recommended ones of the unoccupied seats of the one of the vehicles.

In further features, the rideshare system includes the computing device configured to display, on a display, a graphical user interface including: a configuration of all of the seats of the one of the vehicles; visual indicators of the occupied seats of the one of the vehicles; and visual indicators of the recommended ones of the unoccupied seats of the one of the vehicles.

In further features, the seat module is further configured to determine the configuration of all of the seats of the one of the vehicles based on the unique identifier of the one of the vehicles.

In further features, the seat module is configured to determine the recommended ones of the unoccupied seats based on the pickup location of the ride request.

In further features, the seat module is configured to determine the recommended ones of the unoccupied seats further based on a direction of approach of the one of the vehicles to the pickup location of the ride request.

In further features, the seat module is configured to determine the recommended ones of the unoccupied seats based on the drop-off location of the ride request.

In further features, the seat module is configured to determine the recommended ones of the unoccupied seats further based on a direction of approach of the one of the vehicles to the drop-off location of the ride request.

In further features, the communication module is further configured to obtain, from the computing device for the ride request, a seating preference indicating one of: a preference to sit in a front seat of vehicles; a preference to sit in a rear seat of vehicles; and no preference. The seat module is configured to determine the recommended ones of the unoccupied seats based on the seating preference.

In further features, the communication module is further configured to obtain, from the computing device for the ride request, a seating preference indicating one of: a preference to sit in forward facing seats of vehicles; a preference to sit in rear facing seats of vehicles; and no preference. The seat module is configured to determine the recommended ones of the unoccupied seats based on the seating preference.

In further features: the communication module is further configured to obtain, from the computing device for the ride request, a seating preference; and the seat module is configured to determine the recommended ones of the unoccupied seats based on the pickup location of the ride request, a first direction of approach of the one of the vehicles to the pickup location of the ride request, the drop-off location of the ride request, a second direction of approach of the one of the vehicles to the drop-off location of the ride request, and the seating preference.

In further features: the seat module is configured to determine the recommended ones of the unoccupied seats when the location of the one of the vehicles is less than a predetermined distance from the pickup location; and the communications module is configured to transmit the indicators of the occupied seats of the one of the vehicles and the one or more indicators of the recommended ones of the unoccupied seats of the one of the vehicles in response to the determination of the recommended ones of the unoccupied seats.

In further features: the seat module is configured to determine the recommended ones of the unoccupied seats when an estimated period of arrival of the one of the vehicles at the pickup location less than a predetermined period; and the communications module is configured to transmit the indicators of the occupied seats of the one of the vehicles and the one or more indicators of the recommended ones of the unoccupied seats of the one of the vehicles in response to the determination of the recommended ones of the unoccupied seats.

In further features, the vehicles of the fleet of vehicles includes only land vehicles.

In further features, the rideshare system further includes the one of the vehicles, and the one of the vehicles includes: seat occupancy sensors that are implemented within the seats, respectively, of the one of the vehicles and that are configured to indicate whether the respective seats are occupied or not occupied; and a transceiver configured to wirelessly transmit the indications of the seat occupancy sensors.

In further features, the seat occupancy sensors are configured to indicate that the respective seats are occupied in response to at least a predetermined mass being present upon the respective seats.

In further features, the rideshare system further includes the one of the vehicles, and the one of the vehicles includes: a camera configured to capture images of the seats of the one of the vehicles and indicate, based on the images, whether the respective seats are occupied or not occupied; and a transceiver configured to wirelessly transmit the indications of the camera.

In a feature, a rideshare method includes: obtaining, by a server from a computing device, a ride request including: a pickup location; a drop-off location; and a first number of passengers to transport; obtaining, by the server, from each vehicle of a fleet of vehicles: a unique identifier of the vehicle; a location of the vehicle; and a seat occupancy of the vehicle including, for each seat of the vehicle, an indicator of whether the seat is presently: occupied by a passenger; or not occupied by a passenger; selecting, by the server for the ride request, one of the vehicles of the fleet of vehicles in response to a determination that: the seat occupancy of the one of the vehicles indicates that the one of the vehicles has a second number of unoccupied seats; and the second number of unoccupied seats is greater than or equal to the first number of passengers to transport; by the server, selectively determining recommended ones of the unoccupied seats of the one of the vehicles for the first number of passengers to occupy during transport; and transmitting, by the server to the computing device for display by the computing device, indicators of the occupied seats of the one of the vehicles and one or more indicators of the recommended ones of the unoccupied seats of the one of the vehicles.

In further features, the rideshare method further includes displaying on a display, by the computing device, a graphical user interface including: a configuration of all of the seats of the one of the vehicles; visual indicators of the occupied seats of the one of the vehicles; and visual indicators of the recommended ones of the unoccupied seats of the one of the vehicles.

In a feature, a rideshare system includes a communication module configured to: obtain, from a computing device, a ride request including: a pickup location; a drop-off location; and a first number of passengers to transport; and obtain, from each vehicle of a fleet of vehicles: a unique identifier of the vehicle; a location of the vehicle; and a seat occupancy of the vehicle including, for each seat of the vehicle, an indicator of whether the seat is presently: occupied by a passenger; or not occupied by a passenger. A vehicle selection module is configured to select, for the ride request, one of the vehicles of the fleet of vehicles in response to a determination that: the seat occupancy of the one of the vehicles indicates that the one of the vehicles has a second number of unoccupied seats; and the second number of unoccupied seats is greater than or equal to the first number of passengers to transport. A seat module is configured to: determine recommended ones of the unoccupied seats of the one of the vehicles for the first number of passengers to occupy during transport based on: the pickup location of the ride request; a first direction of approach of the one of the vehicles to the pickup location of the ride request; the drop-off location of the ride request; a second direction of approach of the one of the vehicles to the drop-off location of the ride request; a seating preference including at least one of: a preference to sit in a front seat of vehicles; a preference to sit in a rear seat of vehicles; a preference to sit in forward facing seats of vehicles; a preference to sit in rear facing seats of vehicles; and no preference; and determine the recommended ones of the unoccupied seats of the one of the vehicles when at least one of: the location of the one of the vehicles is less than a predetermined distance from the pickup location; and an estimated period of arrival of the one of the vehicles at the pickup location less than a predetermined period. The communications module is further configured to transmit, to the computing device for display by the computing device, indicators of the occupied seats of the one of the vehicles and one or more indicators of the recommended ones of the unoccupied seats of the one of the vehicles.

In further features, the rideshare system includes: the computing device configured to display, on a display, a graphical user interface including: a configuration of all of the seats of the one of the vehicles; visual indicators of the occupied seats of the one of the vehicles; and visual indicators of the recommended ones of the unoccupied seats of the one of the vehicles; and the one of the vehicles, the one of the vehicles including: at least one of: seat occupancy sensors that are implemented within the seats, respectively, of the one of the vehicles and that are configured to indicate whether the respective seats are occupied or not occupied; and a camera configured to capture images of the seats of the one of the vehicles and to indicate, based on the images, whether the respective seats are occupied or not occupied; and a transceiver configured to wirelessly transmit the indications of the at least one of the seat occupancy sensors and the camera.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example ride sharing system;

FIG. 2 is a front view of an example implementation of a computing device;

FIG. 3 is a functional block diagram of an example implementation of a computing device;

FIG. 4 is an example user interface displayed by a computing device including a seating recommendation;

FIG. 5 is a functional block diagram of an example implementation of a rideshare server;

FIG. 6 is a functional block diagram of an example implementation of a rideshare server;

FIG. 7 is a top view of an example vehicle; and

FIG. 8 is a flowchart depicting an example method of generating a seating recommendation for a ride request.

In the drawings, reference numbers may be reused to identify similar and/or identical elements.

### DETAILED DESCRIPTION

Rideshare users request transportation from a pickup location to a dropoff location. A vehicle used to transport a rideshare user from their pickup location to their dropoff location may have one or more other rideshare users present within the vehicle upon arrival of the vehicle to pick up the rideshare user. The vehicle may pick up and/or drop off one or more other rideshare users as the vehicle transports the rideshare user from the pickup location to the drop-off location.

Because vehicles used to transport rideshare users may be shared with other rideshare users, a rideshare user may not know what seat of a vehicle the rideshare user should occupy during transport until the vehicle is close enough to the pickup location for the rideshare user to visually determine which one or more seats of the vehicle are not presently occupied. This may slow the rideshare user's entry into the vehicle and decrease productivity of that vehicle.

Additionally, one or more seats of the vehicle may help facilitate a rideshare user's entry into and/or exit from the vehicle (e.g., given the side of the vehicle of the pickup and drop-off locations and the vehicle's approach to the pickup and drop-off locations) more than other seats of the vehicle. A rideshare user sitting in a different seat may slow entry into and/or exit from the vehicle and decrease productivity of that vehicle.

According to the present disclosure, a rideshare server determines a recommended seat of a vehicle based on at least one of: satisfying the rideshare user's seating preferences and facilitating entry and/or exit from the vehicle given the presently unoccupied seats. For example, the rideshare server determines the recommended seat based on the presently unoccupied seats of the vehicle and at least one of the pickup location of the rideshare user, the drop-off location of the rideshare user, the side of the vehicle of the pick-up and drop-off locations, and seating preferences of the rideshare user. Seating preferences include, for example, whether the rideshare user prefers to sit in front seats or rear seats and/or whether the rideshare user prefers to sit in forward facing seats or rearward facing seats.

The rideshare server provides the recommended seat to a computing device of the rideshare user (or a computing device of a rideshare user to be transported for the ride request), such as a smartphone, tablet, or other type of computing device. The rideshare server also provides indicators of occupied seats and unoccupied seats of the vehicle to the computing device. The computing device displays a configuration of the seats of the vehicle (e.g., a top view) on a display. The computing device also displays visual indicators of which one or more seats are presently occupied and a visual indicator of the recommended seat. This provides the rideshare user with the recommended seat and information on which seats are presently occupied and not occupied. The rideshare user's knowledge of the recommended seat, the unoccupied seats, and the occupied seats may help facilitate entry into the vehicle and/or exit from the vehicle, which may enable an increase in productivity of that vehicle.

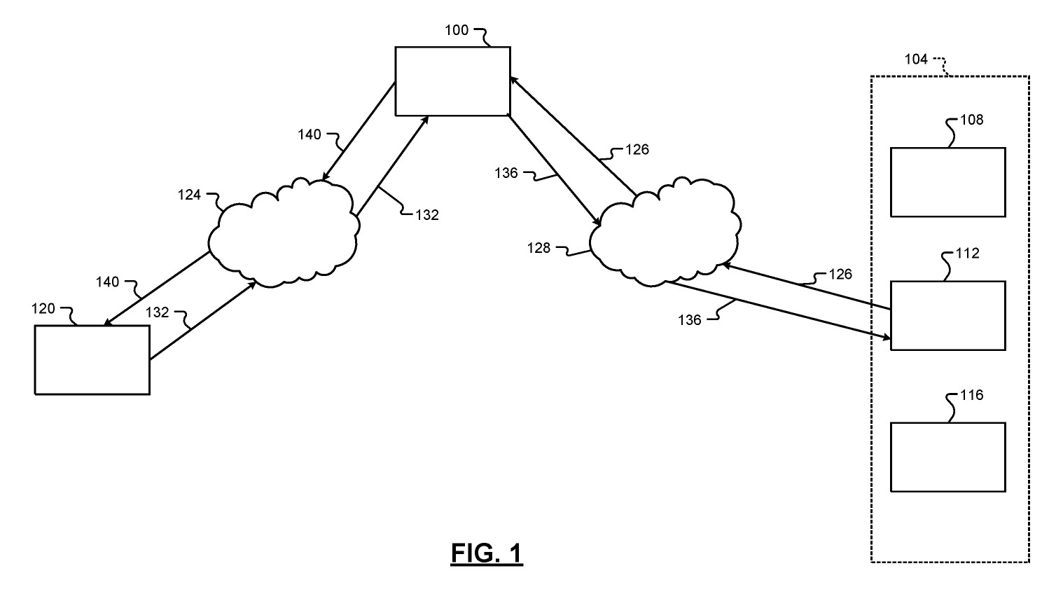

FIG. 1 is a functional block diagram of an example ride sharing system. A rideshare server 100 manages a fleet of vehicles 104 that are used to meet requests from customers for transportation from pickup locations to drop-off locations. The fleet of vehicles 104 includes a plurality of vehicles, such as vehicle 108, vehicle 112, vehicle 116, and a plurality of other vehicles. The fleet of vehicles 104 includes only vehicles that are intended to operate only on land and does not include any vehicles that operate at least partially in the air or on water. The fleet of vehicles 104 may include autonomous vehicles, non-autonomous (driver driven) vehicles, or a combination of autonomous and non-autonomous vehicles.

Customers transmit requests for transportation to the rideshare server 100 using computing devices, such as computing device 120. Examples of computing devices include mobile phones, tablet devices, laptop computers, desktop computers, and other types of computing devices. In various implementations, one customer may, via one computing device, transmit a request for transportation of another customer having another computing device. Computing devices and the rideshare server 100 communicate via one or more networks 124. The networks 124 may include wireless networks, wired networks, or a combination of wireless and wired networks.

Each of the vehicles of the fleet of vehicles 104 transmits its location (e.g., geographical coordinates) to the rideshare server 100 periodically, such as each predetermined distance travelled or each predetermined period while that vehicle is in service for customer transportation. Each of the vehicles of the fleet of vehicles 104 may determine its location, for example, using a global positioning system (GPS) transceiver of the vehicle or from one or more other sources.

Each of the vehicles of the fleet of vehicles 104 includes a plurality of seats for transporting customers. Each of the vehicles of the fleet of vehicles 104 also transmits its seat occupancy to the rideshare server 100 periodically, such as each time occupancy of a seat changes (from occupied to not occupied or vice versa) or each predetermined period while that vehicle is in service for customer transportation. The seat occupancy of a vehicle may include, for each seat of that vehicle, an indicator of whether that seat is occupied by a customer or not occupied by a customer. Each of the vehicles of the fleet of vehicles 104 also transmits a unique identifier (e.g., VIN number) of that vehicle.

An example table indicative of seat occupancy for a vehicle having 4 seats is provided below. In the example table, a Y indicates that the corresponding seat in that row of the table is presently occupied by a customer while a N indicates that the corresponding seat in that row of the table is not presently occupied by a customer.

Example Table 1 - Seat Occupancy

| Seat | Occupancy |
|---|---|
| Left Front | N |
| Right Front | Y |
| Left Rear | N |
| Right Rear | N |

As an example, the vehicle 112 is illustrated in FIG. 1 as transmitting its location and seat occupancy 126 to the rideshare server 100. Each of the other vehicles of the fleet of vehicles 104 periodically transmits its location and seat occupancy to the rideshare server 100. Vehicles and the rideshare server 100 communicate via one or more networks 128. The networks 128 may include wireless networks or a combination of wireless and wired networks.

The rideshare server 100 schedules vehicles of the fleet of vehicles 104 to transport customers to meet requests from the customers for transportation. These requests may be referred to as ride requests. As an example, the computing device 120 transmits a ride request 132 to the rideshare server 100 in response to receipt of user input to the computing device 120 indicative of a request for transportation.

The ride request 132 includes a pickup location (e.g., an address or geographical coordinates) and a drop-off location (e.g., an address or geographical coordinates). The ride request 132 also includes a number of customers to be transported from the pickup location to the dropoff location, one or more seating preferences of the customer, and other data. Seating preferences may include, for example, whether the customer prefers to sit in a front seat or a rear seat of a vehicle or whether the customer prefers to sit in a forward facing seat or a rearward facing seat. A customer may set seating preferences via the computing device 120 or via another computing device. By default, without user input indicative of a seating preference, the seating preferences may be set to no preference. The pickup location, the drop-off location, the number of customers to be transported are input by the customer via the computing device 120.

Based on the ride request 132, the rideshare server 100 selects one of the vehicles of the fleet of vehicles 104 to transport the customer (and any accompanying customers) from the pickup location to the drop-off location. The rideshare server 100 selects the one of the vehicles based on the one of the vehicles having at least the number of unoccupied seats as the number of customers that are to be transported from the pickup location to the drop-off location. The rideshare server 100 may select the one of the vehicles further based on the pickup location, the drop-off location, the locations of the vehicles of the fleet of vehicles 104, the unoccupied seats of the vehicles of the fleet of vehicles 104, the seating preferences of the customer, and other parameters.

As an example, the rideshare server 100 may select the vehicle 112 to transport the customer from the pickup location to the drop-off location and satisfy the ride request 132. The rideshare server 100 determines ride info 136 for the ride request 132 and transmits the ride info 136 to the vehicle 112. The ride info 136 includes, for example, a route for the vehicle 112 to travel to pick up the customer at the pickup location, drop the customer off at the drop-off location, and to pick up and drop off other customers that the vehicle 112 is assigned to transport. The rideshare server 100 may update the ride info 136 periodically, such as when the vehicle 112 deviates from the route, when the rideshare server 100 assigns the vehicle 112 to transport one or more other customers for other ride requests, and/or for one or more other reasons. The vehicle 112 (via the driver or autonomously) moves based on the ride info 136.

The customer, however, may not know which seat of the vehicle 112 that the customer may sit in during transportation. The customer also may not know which seats of the vehicle 112 are occupied until the vehicle 112 is close enough for the customer to visually identify which seats are occupied and which seats are not occupied. The customer also may not know which one or more seats of the vehicle 112 will best facilitate entry into and/or exit from the vehicle 112 given the pickup and drop-off locations and the directions of approach of the vehicle 112 to the pickup and drop-off locations.

The rideshare server 100 therefore determines a seating recommendation 140 for the transportation of the customer for the ride request 132 and transmits the seating recommendation 140 to the computing device 120. In various implementations, a different computing device may generate and transmit the ride request 132 for transportation of a customer associated with computing device 120. The seating recommendation 140 includes a recommended seat for the customer (and any accompanying customers) to occupy upon the vehicle 112 arriving at the pickup location. The rideshare server 100 determines the seating recommendation 140 based on the unoccupied seats of the vehicle 112, the seating preference of the customer, the seating configuration of the vehicle 112, the route, the side (left or right) of the vehicle 112 that will face the curb at the pickup location, and the side of the vehicle 112 that will face the curb at the drop-off location.

The seating recommendation 140 also includes the seating configuration of the vehicle 112 and the seating occupancy of the vehicle 112. In response to receipt of the seating recommendation 140, the computing device 120 displays on a display a graphical user interface (GUI) including a view including: the seating configuration of the vehicle 112, indicators of whether each of the seats is occupied or unoccupied, and one or more indicators of recommended seats for the customer (and any accompanying customers) to occupy upon the vehicle 112 arriving at the pickup location. This will allow for more efficient entry and exit of the vehicle 112 by the customer. More efficient entry and exit of the vehicle 112 allows the vehicle 112 to spend more time transporting customers, which may allow for the vehicle 112 to transport more passengers per predetermined period and/or to travel a longer distance for customer transportation per predetermined period. As discussed further below, the rideshare server 100 may update the seating recommendation 140 periodically before the vehicle 112 arrives at the pickup location, such as when occupancy of one or more of the seats of the vehicle change or a period or distance until the vehicle 112 reaches the pickup location is less than a predetermined period or a predetermined distance.

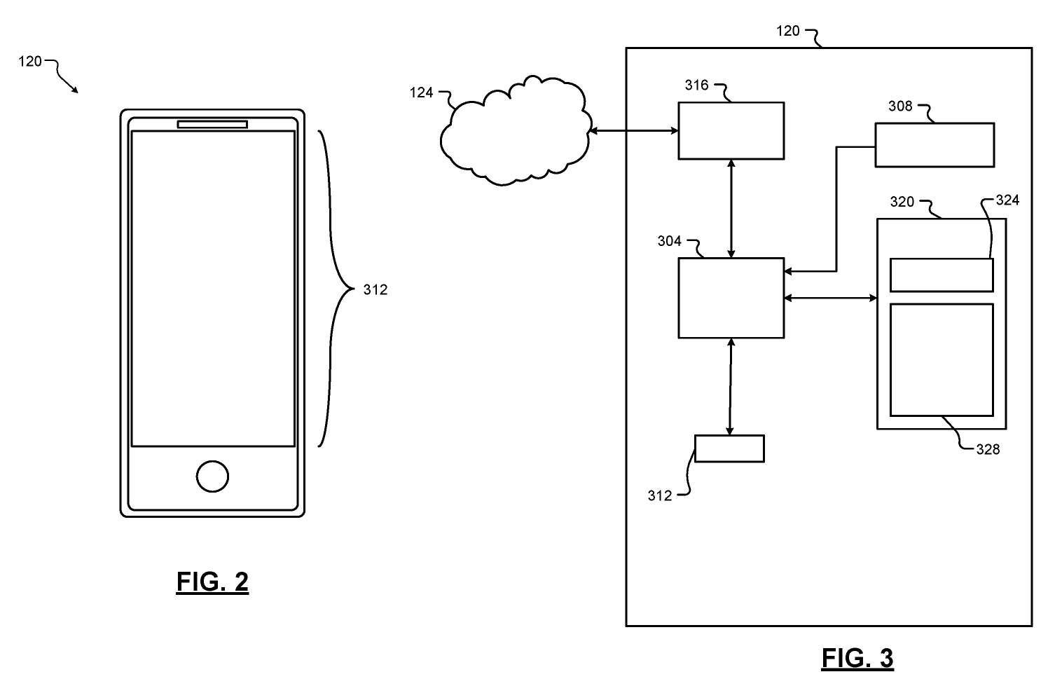

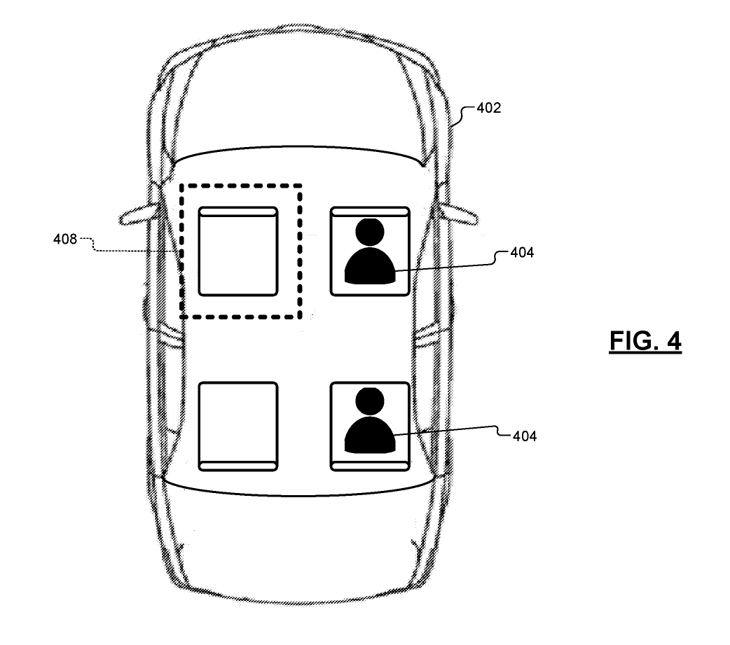

FIG. 2 includes a front view of an example implementation of the computing device 120. FIG. 3 includes a functional block diagram of an example implementation of the computing device 120. Referring now to FIGS. 2 and 3, the computing device 120 includes a central processing unit (CPU) or processor 304, one or more input devices 308 (e.g., touchscreen display, a microphone, one or more switches, etc.), a display 312 (e.g., the touchscreen display), one or more other output devices (not shown), a network interface 316, and memory 320. While the input devices 308 and the display 312 are illustrated as components of the computing device 120, input devices and output devices (e.g., a display) may be peripheral devices. Also, while the example of a single processor is provided, the computing device 120 may include two or more processors.

The network interface 316 connects the computing device 120 to the networks 124. For example, the network interface 316/8 may include a wired interface (e.g., an Ethernet interface) and/or a wireless interface (e.g., a Wi-Fi, Bluetooth, near field communication (NFC), or other wireless interface). The processor 304 of the computing device 120 executes an operating system (OS) 324 and one or more other applications. The processor 304 executes a rideshare application 328 to display user interfaces for generating and transmitting ride requests and for displaying seating occupancy and seating recommendations. Operations discussed herein as being performed by the computing device 120 are performed by the computing device 120 (more specifically the processor 304) during execution of the rideshare application 328.

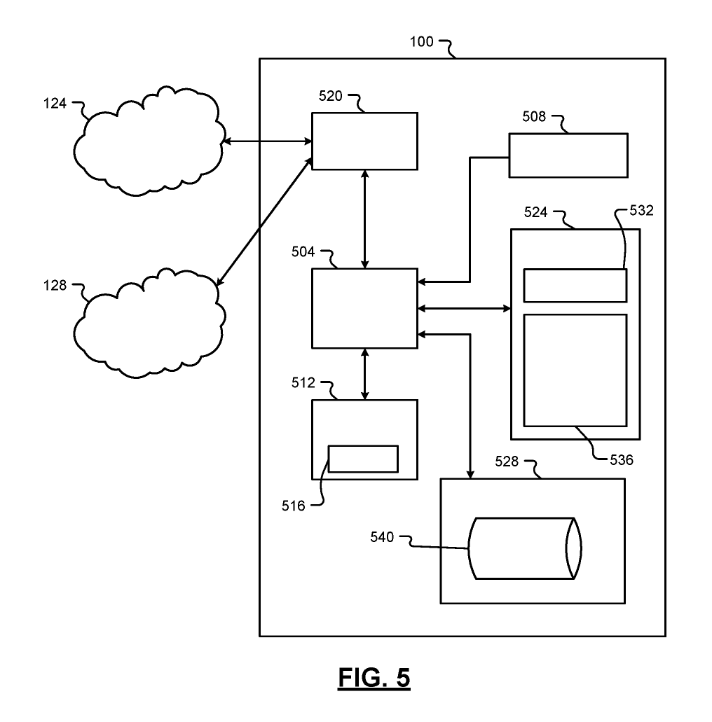

FIG. 4 is an example user interface displayed by the computing device 120 in response to a seating recommendation. The computing device 120 displays a view (e.g., a top view) of the seats of a selected vehicle 402 of the fleet of vehicles 104 based on the configuration of the seats of the vehicle 402 included in the seating recommendation. The computing device 120 displays one or more occupied seat indicators, such as 404, on, around, or otherwise in association with ones of the seats of the vehicle 402 that are presently occupied. In the example of FIG. 4, the front right and rear right seats are indicated as presently occupied.

The computing device 120 also displays one or more recommended seat indicators, such as indicator 408, on, around, or otherwise in association with the one or more (unoccupied) seats recommended for the customer (and any accompanying customers) to occupy when the vehicle arrives at the pickup location and during travel to the drop-off location. In the example of FIG. 4, the front left seat is indicated as being recommended to the customer.

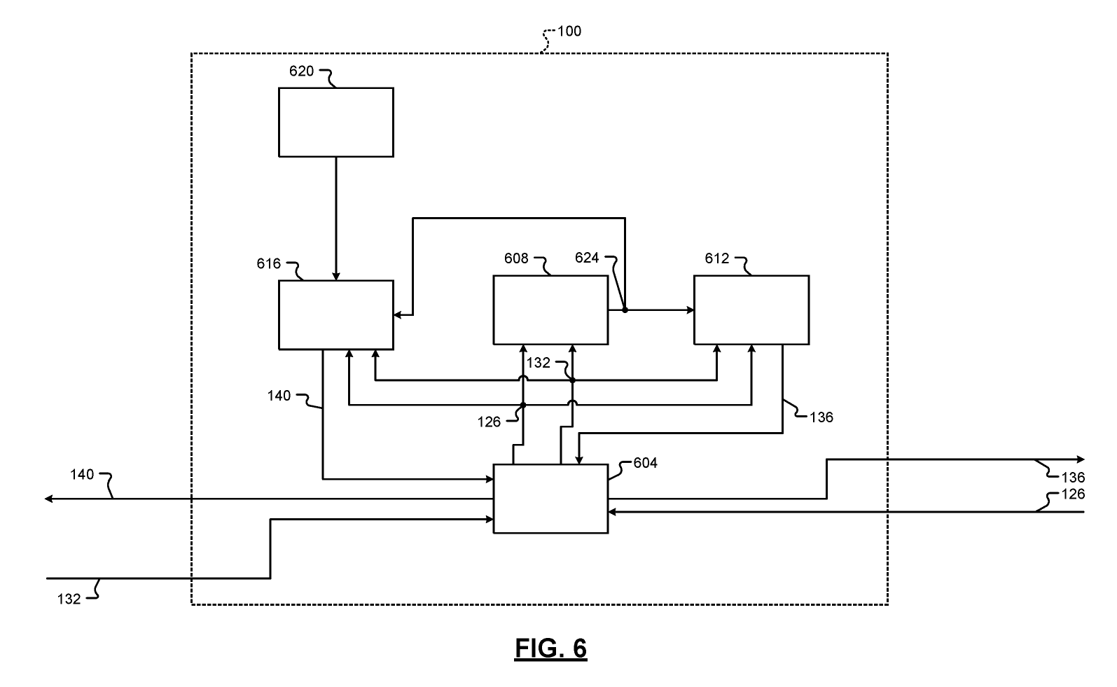

FIG. 5 includes a simplified functional block diagram of an example implementation of the rideshare server 100. The rideshare server 100 includes a processor 504, one or more input devices 508 (e.g., a keyboard, touchpad, mouse, etc.), a display subsystem 512 including a display 516, a network interface 520, a memory 524, and a bulk storage 528. While the input devices 508 and the display 516 are illustrated as components of the rideshare server 100, input devices and output devices (e.g., a display) may be peripheral devices. Also, while the example of a single processor is provided, the rideshare server 100 may include two or more processors.

The network interface 520 connects the rideshare server 100 to the fleet of vehicles 104 via the networks 128 and to the computing device 120 and other computing devices via the networks 124. For example, the network interface 520 may include a wired interface (e.g., an Ethernet interface) and/or a wireless interface (e.g., a Wi-Fi, Bluetooth, near field communication (NFC), or other wireless interface). The memory 524 may include volatile or nonvolatile memory, cache, or other type of memory. The bulk storage 528 may include flash memory, one or more hard disk drives (HDDs), or other bulk storage device.

The processor 504 executes an operating system (OS) 532 and one or more server applications, such as a fleet management application 536. The bulk storage 528 may store one or more databases 540 that store data structures used by the server applications to perform functions described herein. The processor 504 executes the fleet management application 536 to select vehicles for ride requests, generate ride info for ride requests, and generate seating recommendations. Operations discussed herein as being performed by the rideshare server 100 are performed by the rideshare server 100 (more specifically the processor 504) during execution of the fleet management application 536. While functions described herein as being performed by the rideshare server 100, functionality of the rideshare server 100 may distributed amongst two or more servers.

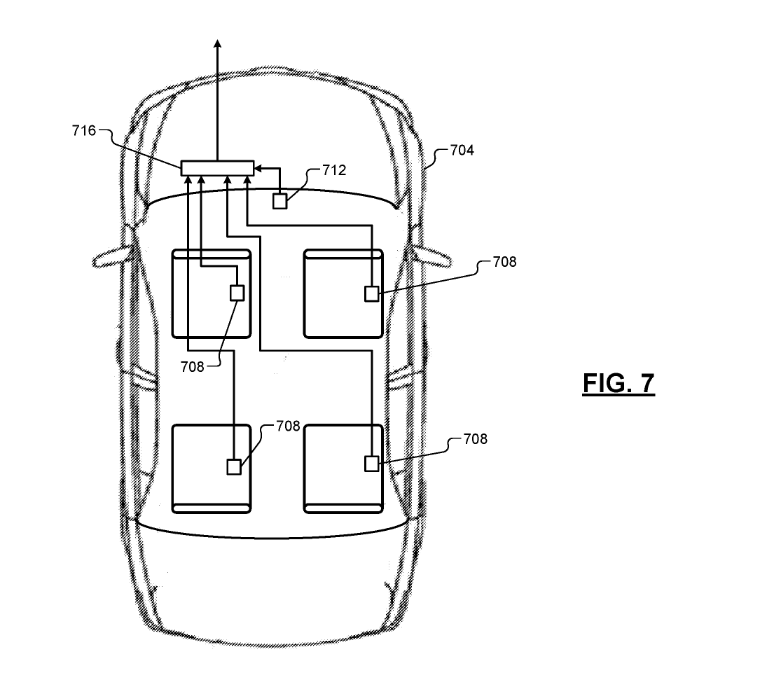

FIG. 6 includes a functional block diagram of an example implementation of the rideshare server 100. The rideshare server 100 includes a communication module 604, a vehicle selection module 608, a route module 612, a seat module 616, and a vehicle database 620. The functionality of the vehicle selection module 608, the route module 612, and the seat module 616 may be embodied as one or more server applications and may be realized via execution by the processor 504.

The communication module 604 receives and transmits data from and to computing devices, such as the computing device 120. For example, the communication module 604 receives ride requests from computing devices, such as the ride request 132, and transmits ride confirmations and seating recommendations, such as the seating recommendation 140, to computing devices transmitting the respective ride requests. As another example, the communication module 604 receives locations and occupancy info, such as the location and seat occupancy 126, from respective vehicles and transmits ride info, such as the ride info 136, to the respective vehicles.

The vehicle selection module 608 tracks the present location and seating occupancy of each of the vehicles of the fleet of vehicles 104. When a ride request is received, the vehicle selection module 608 selects one vehicle 624 of the fleet of vehicles 104 to provide transportation for the received ride request. The vehicle selection module 608 selects the one vehicle 624 based on the one vehicle 624 having at least the number of unoccupied seats as the number of customers that are to be transported from the pickup location to the drop-off location for the ride request. The rideshare server 100 may select the one vehicle 624 further based on the pickup location, the drop-off location, the locations of the other vehicles of the fleet of vehicles 104, the unoccupied seats of the vehicles of the fleet of vehicles 104, the seating preferences of the customer, and other parameters.

The route module 612 generates ride info (e.g., the ride info 136) for the received ride request and the one vehicle 624 selected for the ride request (e.g., the ride request 132). As discussed above, the ride info includes, for example, a route for the one vehicle 624 to travel to pick up the customer at the pickup location, drop the customer off at the drop-off location, and to pick up and drop off other customers that the one vehicle 624 is assigned to transport. The route module 612 may update the ride info periodically, such as when the one vehicle 624 deviates from the route, when the one vehicle 624 is selected to transport one or more other customers for other received ride requests, and/or for one or more other reasons.

A seating configuration of each vehicle of the fleet of vehicles 104 is stored in the vehicle database 620. The seat module 616 tracks the present seating occupancy of each of the vehicles of the fleet of vehicles 104. When one of the vehicles is selected for a received ride request, the seat module 616 determines the seating configuration of the one vehicle 624 selected for the received ride request from the vehicle database 620 using the unique identifier of the one vehicle 624. The vehicle database 620 may include seating configurations indexed by unique identifiers of the vehicles of the fleet of vehicles 104.

The seat module 616 determines a seating recommendation (e.g., the seating recommendation 140) for the received ride request based on the seating configuration of the one vehicle 624. The seat module 616 determines the seating recommendation further based on the unoccupied seats of the one vehicle 624, the seating preference of the customer (provided in the received ride request), the route (included in the ride info), the side (left or right) of the one vehicle 624 that will face the curb at the pickup location, and the side of the one vehicle 624 that will face the curb at the drop-off location. The seat module 616 may determine which side of the one vehicle 624 at the pickup location or the drop-off location, for example, based on the route and (street) addresses at the pickup and drop-off locations. For example, even numbered street addresses may be on one side of a street while odd numbered street addresses may be on the other side of the street.

The seating recommendation includes a recommended seat for the customer (and any accompanying customers) to occupy upon the one vehicle 624 arriving at the pickup location. The seating recommendation also includes the seating configuration of the one vehicle 624 and the present seating occupancy of the one vehicle 624.

For a received ride request, the communication module 604 transmits the determined seating recommendation to the computing device from which the ride request was received. The computing device displays, on a display, a graphical user interface including: the seating configuration of the one vehicle 624, indicators of whether each of the seats is occupied or unoccupied, and one or more indicators of recommended seats for the customer (and any accompanying customers) to occupy upon the one vehicle 624 arriving at the pickup location. This will allow for more efficient entry and exit of the one vehicle 624 by the customer. More efficient entry and exit of the one vehicle 624 allows the one vehicle 624 to spend more time transporting customers, which may allow for the one vehicle 624 to transport more passengers per predetermined period and/or to travel a longer distance for customer transportation per predetermined period.

In various implementations, the seat module 616 may determine a different seating recommendation for a received ride request before the one vehicle 624 arrives at the pickup location. For example, the seat module 616 may determine a new seating recommendation when occupancy of one or more of the seats of the vehicle change. Additionally or alternatively, the seat module 616 may determine a new seating recommendation when the recommended seat(s) of the previous (e.g., last) seating recommendation are occupied before the one vehicle 624 arrives at the pickup location. Additionally or alternatively, the seat module 616 may determine a new seating recommendation when a period or distance until the one vehicle 624 reaches the pickup location is less than the predetermined period or the predetermined distance. The predetermined period and the predetermined distance may be calibratable. The predetermined period may be, for example, 1 minute, 2 minutes, 3 minutes, or another suitable period before the vehicle is expected to arrive at the pickup location. The predetermined distance may be, for example, 1 mile, 2 miles, 3 miles, or another suitable distance between the vehicle and the pickup location.

FIG. 7 includes an example top view of an example vehicle 704. Each vehicle of the fleet of vehicles 104 includes one or more seat occupancy sensors that determine and indicate whether one or more of the seats of the vehicle are presently occupied or not. For example, the vehicle 704 includes one seat sensor 708 in each seat, such as in a cushion of each seat. Each seat sensor may indicate that its seat is occupied when at least a predetermined mass or weight is present on the cushion of its seat. Each seat sensor may indicate that its seat is not occupied when at least the predetermined mass or weight is present on the cushion of its seat.

Vehicles of the fleet of vehicles 104 may additionally or alternatively include one or more other seat occupancy sensors. For example, the vehicle 704 may additionally or alternatively include one or more cameras, such as camera 712, configured to capture images including the seats and any occupants sitting on the seats. The camera(s) may indicate that a seat is occupied when a predetermined shape of an occupant is captured in that seat in an image. The camera(s) may indicate that a seat is not occupied when the predetermined shape of an occupant is not captured in that seat in an image.

Each vehicle of the fleet of vehicles 104 includes one or more transceivers, such as transceiver 716, that determines the location of the vehicle, that transmits the seating occupancy and the location to the rideshare server 100 wirelessly, and that receives ride info. Examples of transceivers that determine location include global positioning system (GPS) transceivers. Examples of transceivers that transmit location and seat occupancy and receive ride info include, for example, cellular transceivers, WiFi transceivers, and other types of transceivers.

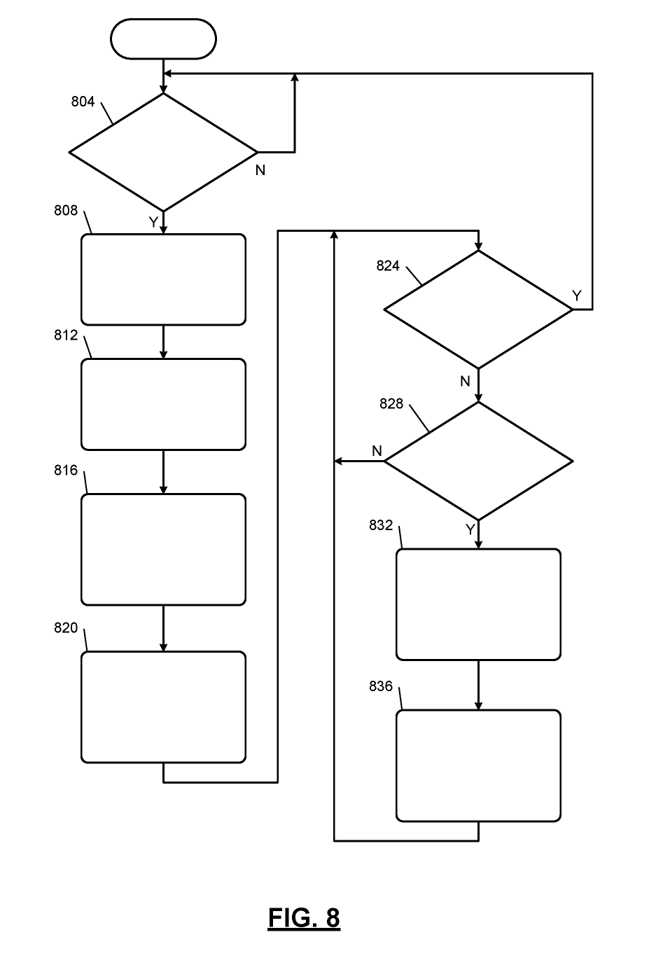

FIG. 8 is a flowchart depicting an example method of generating a seating recommendation for a ride request that may be performed by the rideshare server 100. As discussed above, the vehicle selection module 608 tracks the location and seat occupancy of the vehicles of the fleet of vehicles 104. Control begins with 804 where the communication module 604 receives a ride request from a computing device. For example, the communication module 604 may receive the ride request 132 from the computing device 120.

At 808, the vehicle selection module 608 selects one of the vehicles of the of the fleet of vehicles 104 to satisfy the ride request. The vehicle selection module 608 selects the one of the vehicles for the ride request based on the one vehicle 624 having at least the number of unoccupied seats as the number of customers that are to be transported for the ride request, the location of the vehicle, the pickup location, the drop-off location, the locations of the other vehicles of the fleet of vehicles 104, the unoccupied seats of the vehicles of the fleet of vehicles 104, the seating preferences of the customer, and other parameters. For example, the vehicle selection module 608 may select the vehicle 112 to satisfy the ride request 132.

At 812, the route module 612 determines the ride info for the ride request given the selected one of the vehicles of the fleet of vehicles 104. The route module 612 generates the ride info for the ride request based on the pickup location, the drop-off location, the present location of the selected one of the vehicles, and the routes to be taken to pick up and drop off one or more other customers (already occupying the vehicle and/or later requesting rides) that the selected one of the vehicles is selected to transport. The communication module 604 transmits the ride info to the selected one of the vehicles. For example, the route module 612 may determine the ride info 136 for the ride request 132 and transmit the ride info 136 to the vehicle 112. The vehicle 112 may drive based on the ride info 136 or a driver of the vehicle 112 may drive the vehicle based on the ride info 136. The route module 612 may update the ride info under some circumstances.

At 816, the seat module 616 determines the seating configuration of the selected one of the vehicles from the vehicle database 620. The seat module 616 determines a seating recommendation for the ride request based on the seating configuration of the selected one of the vehicles and the unoccupied seats of the selected one of the vehicles. The seat module 616 may determine the seating recommendation further based on at least one of the seating preference of the customer (provided in the received ride request), the route (included in the ride info), the side (left or right) of the selected one of the vehicles that will face the curb at the pickup location, and the side of the selected one of the vehicles that will face the curb at the drop-off location. The communication module 604 transmits the seating recommendation to the computing device from which the ride request was received. For example, the seat module 616 may determine the seating recommendation 140 for the ride request 132 from the computing device 120, and the communication module 604 transmits the seating recommendation 140 to the computing device 120.

At 820, the computing device displays a GUI including a view (e.g., a top view of the selected one of the vehicles) including: the seating configuration of the selected one of the vehicles, indicators of whether each of the seats is occupied or unoccupied, and one or more indicators of recommended seats for the customer (and any accompanying customers) to occupy upon the selected one of the vehicles arriving at the pickup location. For example, the computing device 120 may display the seating recommendation 140 on a display (e.g., a display of the computing device 120). An example is provided in FIG. 7.

At 824, the seat module 616 determines whether the selected one of the vehicles is at the pickup location of the ride request. For example, the seat module 616 may determine whether the location of the selected one of the vehicles is approximately the same as (e.g., within a second predetermined distance of) the pickup location. If 824 is true, control may return 804 or end. If 824 is false, control may continue with 828.

At 828, the seat module 616 determines whether to update seating recommendation. For example, the seat module 616 may determine whether the occupancy of one or more of the seats of the selected one of the vehicles has changed since the seat module 616 last determined the seating recommendation. Additionally or alternatively, the seat module 616 may determine whether the vehicle is less than the predetermined period or the predetermined distance to the pickup location. If 828 is true, control continues with 832. If 828 is false, control may return to 824.

At 832, the seat module 616 determines the seating configuration of the selected one of the vehicles from the vehicle database 620. The seat module 616 also determines a seating recommendation for the ride request based on the seating configuration of the selected one of the vehicles and the unoccupied seats of the selected one of the vehicles. The seat module 616 may determine the seating recommendation further based on at least one of the seating preference of the customer (provided in the received ride request), the route (included in the ride info), the side (left or right) of the selected one of the vehicles that will face the curb at the pickup location, and the side of the selected one of the vehicles that will face the curb at the drop-off location. The communication module 604 transmits the seating recommendation to the computing device from which the ride request was received. For example, the seat module 616 may determine the seating recommendation 140 for the ride request 132 from the computing device 120, and the communication module 604 transmits the seating recommendation 140 to the computing device 120.

At 836, the computing device displays a GUI including a view (e.g., a top view of the selected one of the vehicles) including: the seating configuration of the selected one of the vehicles, indicators of whether each of the seats is occupied or unoccupied, and one or more indicators of recommended seats for the customer (and any accompanying customers) to occupy upon the selected one of the vehicles arriving at the pickup location. For example, the computing device 120 may display the seating recommendation 140 on a display (e.g., a display of the computing device 120). An example is provided in FIG. 7. Control then returns to 824.

The predetermined period and the predetermined distance may be calibratable. The predetermined period may be, for example, 1 minute, 2 minutes, 3 minutes, or another suitable period before the vehicle is expected to arrive at the pickup location. The predetermined distance may be, for example, 1 mile, 2 miles, 3 miles, or another suitable distance between the vehicle and the pickup location. Below an example table of seating recommendations provided for a first ride request for a first customer (customer A) and a second ride request for a second customer (customer B) given various possible seating preferences of the first and second customers and seating occupancies of the vehicle. The example table below illustrates the possible seating recommendations for the example where the pickup and drop-off locations for the first and second customers will both be on the right of the vehicle.

| | | | | | | | | Seating Recommendation | | | |
|---|---|---|---|---|---|---|---|---|---|---|---|
| | | | | | | | | R = Recommend, | | | |
| | | | | A | A | B | B | O = Occupied, | | | |
| | # of | | | Pick | Drop- | Pick- | Drop- | U = Unoccupied | | | |
| | Existing | A Seating | B Seating | Up | Off | Up | Off | Front | Front | Rear | Rear |
| Customer | Passengers | Preference | Preference | Side | Side | Side | Side | Right | Left | Right | Left |
| A | 0 | None | N/A | Right | Right | N/A | N/A | U | U | R | U |
| A | 0 | Front | N/A | Right | Right | N/A | N/A | R | U | U | U |
| A | 0 | Rear | N/A | Right | Right | N/A | N/A | U | U | R | U |
| B | 1 | None | None | Right | Right | Right | Right | R | U | O | U |
| B | 1 | Front | None | Right | Right | Right | Right | O | U | R | U |
| B | 1 | Rear | None | Right | Right | Right | Right | R | U | O | U |
| B | 1 | None | Front | Right | Right | Right | Right | R | U | O | U |
| B | 1 | Front | Front | Right | Right | Right | Right | O | U | R | U |
| B | 1 | Rear | Front | Right | Right | Right | Right | R | U | O | U |
| B | 1 | None | Rear | Right | Right | Right | Right | R | U | O | U |
| B | 1 | Front | Rear | Right | Right | Right | Right | O | U | R | U |
| B | 1 | Rear | Rear | Right | Right | Right | Right | R | U | O | U |
| B | 2 | None | None | Right | Right | Right | Right | R | U | O | O |
| B | 2 | Front | None | Right | Right | Right | Right | O | O | R | U |
| B | 2 | Rear | None | Right | Right | Right | Right | R | U | O | O |
| B | 2 | None | Front | Right | Right | Right | Right | R | U | O | O |
| B | 2 | Front | Front | Right | Right | Right | Right | O | O | R | U |
| B | 2 | Rear | Front | Right | Right | Right | Right | R | U | O | O |
| B | 2 | None | Rear | Right | Right | Right | Right | R | U | O | O |
| B | 2 | Front | Rear | Right | Right | Right | Right | O | O | R | U |
| B | 2 | Rear | Rear | Right | Right | Right | Right | R | U | O | O |

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A rideshare system comprising:
a communication module configured to:
obtain, from a computing device, a ride request including:
a pickup location;
a drop-off location; and
a first number of passengers to transport; and
obtain, from each vehicle of a fleet of vehicles:
a unique identifier of the vehicle;
a location of the vehicle; and
a seat occupancy of the vehicle including, for each seat of the vehicle, an indicator of whether the seat is presently:
occupied by a passenger; or
not occupied by a passenger;
a vehicle selection module configured to select, for the ride request, one of the vehicles of the fleet of vehicles in response to a determination that:
the seat occupancy of the one of the vehicles indicates that the one of the vehicles has a second number of unoccupied seats; and
the second number of unoccupied seats is greater than or equal to the first number of passengers to transport; and
a seat module configured to selectively determine recommended ones of the unoccupied seats of the one of the vehicles for the first number of passengers to occupy during transport,
wherein the communications module is further configured to transmit, to the computing device for display by the computing device, indicators of the occupied seats of the one of the vehicles and one or more indicators of the recommended ones of the unoccupied seats of the one of the vehicles.

2. The rideshare system of claim 1 further comprising the computing device,
wherein the computing device is configured to display, on a display, a graphical user interface including:
a configuration of all of the seats of the one of the vehicles;
visual indicators of the occupied seats of the one of the vehicles; and
visual indicators of the recommended ones of the unoccupied seats of the one of the vehicles.

3. The rideshare system of claim 1 wherein the seat module is further configured to determine the configuration of all of the seats of the one of the vehicles based on the unique identifier of the one of the vehicles.

4. The rideshare system of claim 1 wherein the seat module is configured to determine the recommended ones of the unoccupied seats based on the pickup location of the ride request.

5. The rideshare system of claim 4 wherein the seat module is configured to determine the recommended ones of the unoccupied seats further based on a direction of approach of the one of the vehicles to the pickup location of the ride request.

6. The rideshare system of claim 1 wherein the seat module is configured to determine the recommended ones of the unoccupied seats based on the drop-off location of the ride request.

7. The rideshare system of claim 6 wherein the seat module is configured to determine the recommended ones of the unoccupied seats further based on a direction of approach of the one of the vehicles to the drop-off location of the ride request.

8. The rideshare system of claim 1 wherein:
the communication module is further configured to obtain, from the computing device for the ride request, a seating preference indicating one of:
a preference to sit in a front seat of vehicles;
a preference to sit in a rear seat of vehicles; and
no preference; and
the seat module is configured to determine the recommended ones of the unoccupied seats based on the seating preference.

9. The rideshare system of claim 1 wherein:
the communication module is further configured to obtain, from the computing device for the ride request, a seating preference indicating one of:
a preference to sit in forward facing seats of vehicles;
a preference to sit in rear facing seats of vehicles; and
no preference; and
the seat module is configured to determine the recommended ones of the unoccupied seats based on the seating preference.

10. The rideshare system of claim 1 wherein:
the communication module is further configured to obtain, from the computing device for the ride request, a seating preference; and
the seat module is configured to determine the recommended ones of the unoccupied seats based on the pickup location of the ride request, a first direction of approach of the one of the vehicles to the pickup location of the ride request, the drop-off location of the ride request, a second direction of approach of the one of the vehicles to the drop-off location of the ride request, and the seating preference.

11. The rideshare system of claim 1 wherein:
the seat module is configured to determine the recommended ones of the unoccupied seats when the location of the one of the vehicles is less than a predetermined distance from the pickup location; and
the communications module is configured to transmit the indicators of the occupied seats of the one of the vehicles and the one or more indicators of the recommended ones of the unoccupied seats of the one of the vehicles in response to the determination of the recommended ones of the unoccupied seats.

12. The rideshare system of claim 1 wherein:
the seat module is configured to determine the recommended ones of the unoccupied seats when an estimated period of arrival of the one of the vehicles at the pickup location less than a predetermined period; and
the communications module is configured to transmit the indicators of the occupied seats of the one of the vehicles and the one or more indicators of the recommended ones of the unoccupied seats of the one of the vehicles in response to the determination of the recommended ones of the unoccupied seats.

13. The rideshare system of claim 1 wherein the vehicles of the fleet of vehicles includes only land vehicles.

14. The rideshare system of claim 1 further comprising the one of the vehicles,
wherein the one of the vehicles includes:
seat occupancy sensors that are implemented within the seats, respectively, of the one of the vehicles and that are configured to indicate whether the respective seats are occupied or not occupied; and
a transceiver configured to wirelessly transmit the indications of the seat occupancy sensors.

15. The rideshare system of claim 14 wherein the seat occupancy sensors are configured to indicate that the respective seats are occupied in response to at least a predetermined mass being present upon the respective seats.

16. The rideshare system of claim 1 further comprising the one of the vehicles,
wherein the one of the vehicles includes:
a camera configured to capture images of the seats of the one of the vehicles and indicate, based on the images, whether the respective seats are occupied or not occupied; and
a transceiver configured to wirelessly transmit the indications of the camera.

17. A rideshare method comprising:
obtaining, by a server from a computing device, a ride request including:
a pickup location;
a drop-off location; and
a first number of passengers to transport; and
obtaining, by the server, from each vehicle of a fleet of vehicles:
a unique identifier of the vehicle;
a location of the vehicle; and
a seat occupancy of the vehicle including, for each seat of the vehicle, an indicator of whether the seat is presently:
occupied by a passenger; or
not occupied by a passenger;
selecting, by the server for the ride request, one of the vehicles of the fleet of vehicles in response to a determination that:
the seat occupancy of the one of the vehicles indicates that the one of the vehicles has a second number of unoccupied seats; and
the second number of unoccupied seats is greater than or equal to the first number of passengers to transport;
by the server, selectively determining recommended ones of the unoccupied seats of the one of the vehicles for the first number of passengers to occupy during transport; and
transmitting, by the server to the computing device for display by the computing device, indicators of the occupied seats of the one of the vehicles and one or more indicators of the recommended ones of the unoccupied seats of the one of the vehicles.

18. The rideshare method of claim 17 further comprising displaying on a display, by the computing device, a graphical user interface including:
a configuration of all of the seats of the one of the vehicles;
visual indicators of the occupied seats of the one of the vehicles; and
visual indicators of the recommended ones of the unoccupied seats of the one of the vehicles.

19. A rideshare system comprising:
a communication module configured to:
obtain, from a computing device, a ride request including:
a pickup location;
a drop-off location; and
a first number of passengers to transport; and
obtain, from each vehicle of a fleet of vehicles:
a unique identifier of the vehicle;
a location of the vehicle; and
a seat occupancy of the vehicle including, for each seat of the vehicle, an indicator of whether the seat is presently:
occupied by a passenger; or
not occupied by a passenger;
a vehicle selection module configured to select, for the ride request, one of the vehicles of the fleet of vehicles in response to a determination that:
the seat occupancy of the one of the vehicles indicates that the one of the vehicles has a second number of unoccupied seats; and
the second number of unoccupied seats is greater than or equal to the first number of passengers to transport; and
a seat module configured to:
determine recommended ones of the unoccupied seats of the one of the vehicles for the first number of passengers to occupy during transport based on:
the pickup location of the ride request;
a first direction of approach of the one of the vehicles to the pickup location of the ride request;
the drop-off location of the ride request;
a second direction of approach of the one of the vehicles to the drop-off location of the ride request;
a seating preference including at least one of:
a preference to sit in a front seat of vehicles;
a preference to sit in a rear seat of vehicles;
a preference to sit in forward facing seats of vehicles;
a preference to sit in rear facing seats of vehicles; and
no preference; and
determine the recommended ones of the unoccupied seats of the one of the vehicles when at least one of:
the location of the one of the vehicles is less than a predetermined distance from the pickup location; and
an estimated period of arrival of the one of the vehicles at the pickup location less than a predetermined period,
wherein the communications module is further configured to transmit, to the computing device for display by the computing device, indicators of the occupied seats of the one of the vehicles and one or more indicators of the recommended ones of the unoccupied seats of the one of the vehicles.

20. The rideshare system of claim 19 further comprising:
the computing device, wherein the computing device is configured to display, on a display, a graphical user interface including:
a configuration of all of the seats of the one of the vehicles;
visual indicators of the occupied seats of the one of the vehicles; and
visual indicators of the recommended ones of the unoccupied seats of the one of the vehicles; and
the one of the vehicles, wherein the one of the vehicles includes:
at least one of:
seat occupancy sensors that are implemented within the seats, respectively, of the one of the vehicles and that are configured to indicate whether the respective seats are occupied or not occupied; and
a camera configured to capture images of the seats of the one of the vehicles and to indicate, based on the images, whether the respective seats are occupied or not occupied; and
a transceiver configured to wirelessly transmit the indications of the at least one of the seat occupancy sensors and the camera.
